(19) United States
(12) Patent Application Publication
(10) Pub. No.: US 2018/0347969 A1
(43) Pub. Date: Dec. 6, 2018

(54) CALIBRATION SYSTEMS FOR CALIBRATING ENERGY EMITTING DEVICES OF ADDITIVE MANUFACTURING SYSTEMS AND RELATED PROGRAM PRODUCTS

(71) Applicant: General Electric Company, Schenectady, NY (US)

(72) Inventors: Dean Andrew Snelling, JR., Greenville, SC (US); Donnell Eugene Crear, Simpsonville, SC (US); Mikhail Pavlov, Dietikon (CH); Felix Martin Gerhard Roerig, Baden (CH)

(21) Appl. No.: 15/608,187

(22) Filed: May 30, 2017

(51) Int. Cl. G01B 11/25; B29C 67/00; B33Y 50/02

(52) U.S. Cl. CPC G01B 11/2504; B33Y 50/02; B29C 67/0088

(57) ABSTRACT

Additive manufacturing systems (AMS) are disclosed. The AMS may include a build platform, and energy emitting device(s) positioned above the build platform. Energy emitting device(s) may be configured to form a test mark directly on a reference surface of the AMS. AMS may also include a calibration system operably connected to the energy emitting device(s). The calibration system may include measurement device(s) configured to determine an actual location of the test mark on the reference surface, and computing device(s) operably connected to the energy emitting device(s) and the measurement device(s). The computing device(s) may be configured to calibrate the energy emitting device(s) by adjusting the energy emitting device(s) in response to determining the actual location of the test mark on the reference surface from a predetermined, desired location on the reference surface.

### BACKGROUND

The disclosure relates generally to additive manufacturing systems, and more particularly, to a calibration system for calibrating energy emitting devices of the additive manufacturing systems and related program products for calibrating the energy emitting devices.

Components or parts for various machines and mechanical systems may be built using additive manufacturing systems. Additive manufacturing systems may build such components by continuously layering powder material in predetermined areas and performing a material transformation process, such as sintering or melting, on the powder material. The material transformation process may alter the physical state of the powder material from a granular composition to a solid material to build the component. The components built using the additive manufacturing systems have nearly identical physical attributes as conventional components typically made by performing machining processes on stock material. However, these components can include certain geometrical features that can only be obtained through additive manufacturing methods.

A variety of operational characteristics for the devices and/or systems of the additive manufacturing system may affect the build of the component formed by additive manufacturing systems. For example, energy emitting devices used to transform the powder material may affect the quality and/or accuracy of the component built by the additive manufacturing system. Energy emitting devices of the additive manufacturing system may emit energy toward powder material deposited on a build plate during the build process. The powder material may be deposited on the build plate for forming the component, and the energy emitting devices may be configured to emit energy to contact and/or to transform (e.g., sinter, melt, cure) the deposited powder material to form the component. The path and/or beam of the energy emitted by the energy emitting devices may be controlled, manipulated and/or directed within the additive manufacturing system using, for example, at least one mirror configured to receive and/or redirect the emitted energy toward the powder material during the build process.

However, over the life of operation of the additive manufacturing system, the position of the energy emitting devices may change and/or the emission path for the emitted energy may drift. That is, after forming a plurality of parts using the additive manufacturing systems, the energy emitting devices may be displaced from a desired position for forming the component and/or the path of energy emitted by the energy emitting device may shift from a desired path when forming the component using the additive manufacturing system. As a result of the energy emitting devices being displaced and/or the path of the energy being shifted, the build quality or accuracy of the build process for forming the component may be negatively impacted. For example, where the energy emitting device is displaced and/or the path of energy emitted by the energy emitting device is shifted from a desired path, portions of the deposited powder material forming the component may not be transformed during the build process. The deposited powder material may not be transformed because the displaced or shifted energy emitting devices may be emitting energy in a path that does not include or pass over the deposited powder material or a desired portion of the deposited powder material. As a result, of not transforming all the deposited powder material, the component formed by the additive manufacturing system including displaced energy emitting devices may include structurally inferior areas or portions (e.g., untransformed powder material) formed in the component and may have a negative impact on the geometrical accuracy. In some cases, this may ultimately reduce the operational efficiencies and/or operational life of the component built by the additive manufacturing systems.

The decrease in build quality and geometrical accuracy may become exponentially more prevalent or obvious in additive manufacturing systems that include multiple energy emitting devices which rely on each other for accurately transforming the powder material to form components. That is, where one or more energy emitting devices is displaced from a desired position for forming the component and/or the path of energy emitted by the energy emitting device may shift from a desired path when forming the component, then each energy emitting device may not accurately transform all of the designated powder material when form the component. For example, where one or more energy emitting devices is displaced and/or the path of energy is shifted, portions of the powder material may not be transformed at all. This may result in untransformed or unchanged powder material and/or an incomplete component. Conversely, where one or more energy emitting devices is displaced and/or the path of energy is shifted, portions of the powder material may be over transformed or undesirably exposed to energy from two energy emitting devices (e.g., double sintering). As a result, the component may include structurally inferior areas or portions (e.g., double-sintered portions), which may reduce the operational efficiencies and/or operational life of the component built by the additive manufacturing systems.

### SUMMARY

A first aspect of the disclosure provides an additive manufacturing system including: a movable build platform; at least one energy emitting device positioned above the movable build platform, the at least one energy emitting device configured to form a test mark directly on a reference surface; and a calibration system operably connected to the at least one energy emitting device, the calibration system including: at least one measurement device positioned above the movable build platform, the at least one measurement device configured to determine an actual location of the test mark on the reference surface; and at least one computing device operably connected to the at least one energy emitting device and the at least one measurement device, the at least one computing device configured to calibrate the at least one energy emitting device by: adjusting the at least one energy emitting device in response to determining the actual location of the test mark on the reference surface differs from a predetermined, desired location on the reference surface.

A second aspect of the disclosure provides a calibration system operably connected to at least one energy emitting device of an additive manufacturing system, the calibration system including: a reference mark formed on a reference surface in a predetermined, desired location; at least one measurement device positioned above the reference surface, the at least one measurement device configured to determine an actual location of a test mark made by the at least one energy emitting device on the reference surface; and at least one computing device operably connected to the at least one energy emitting device and the at least one measurement device, the at least one computing device configured to calibrate the at least one energy emitting device by: adjusting the at least one energy emitting device in response to determining the actual location of the test mark on the reference surface differs from the reference mark formed in the predetermined, desired location on the reference surface.

A third aspect of the disclosure provides a computer program product including program code stored on a non-transitory computer readable storage medium, which when executed by at least one computing device, causes the at least one computing device to calibrate at least one energy emitting device of an additive manufacturing system by performing processes including: adjusting the at least one energy emitting device in response to determining an actual location of a test mark formed on a reference surface of the additive manufacturing system differs from a predetermined, desired location on the reference surface, wherein the at least one energy emitting device is configured to form the test mark directly on the reference surface.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a front view of an additive manufacturing system and a calibration system including measurement device(s) for calibrating energy emitting device(s), according to embodiments.

FIG. 2 shows a top view of the build plate of the additive manufacturing system of FIG. 1 including a test mark and a reference mark formed thereon, according to embodiments.

FIG. 3 shows a top view of the build plate of the additive manufacturing system of FIG. 1 including the test mark formed over the reference mark, according to embodiments.

FIG. 4 shows a top view of the build plate of the additive manufacturing system of FIG. 1 including a test mark and a reference mark formed thereon, according to additional embodiments.

FIG. 5 shows a top view of the build plate of the additive manufacturing system of FIG. 1 including a test mark and a reference mark formed thereon, according to another embodiment.

FIG. 6 shows a front view of an additive manufacturing system and a calibration system including measurement device(s) and calibration plate for calibrating energy emitting device(s), according to additional embodiments.

FIG. 7 shows a front view of an additive manufacturing system and a calibration system including measurement device(s) and calibration plate for calibrating energy emitting device(s), according to other embodiments.

FIG. 8 shows a front view of an additive manufacturing system, a calibration system including measurement device(s) and calibration plate for calibrating energy emitting device(s), and a partially built component, according to embodiments.

FIG. 9 shows an environment including a calibration system for calibrating energy emitting device(s) of the additive manufacturing systems of FIGS. 1, and 6-8, according to embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant machine components within additive manufacturing systems. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure relates generally to additive manufacturing systems, and more particularly, to a calibration system for calibrating energy emitting devices of the additive manufacturing systems and related program products for calibrating the energy emitting devices.

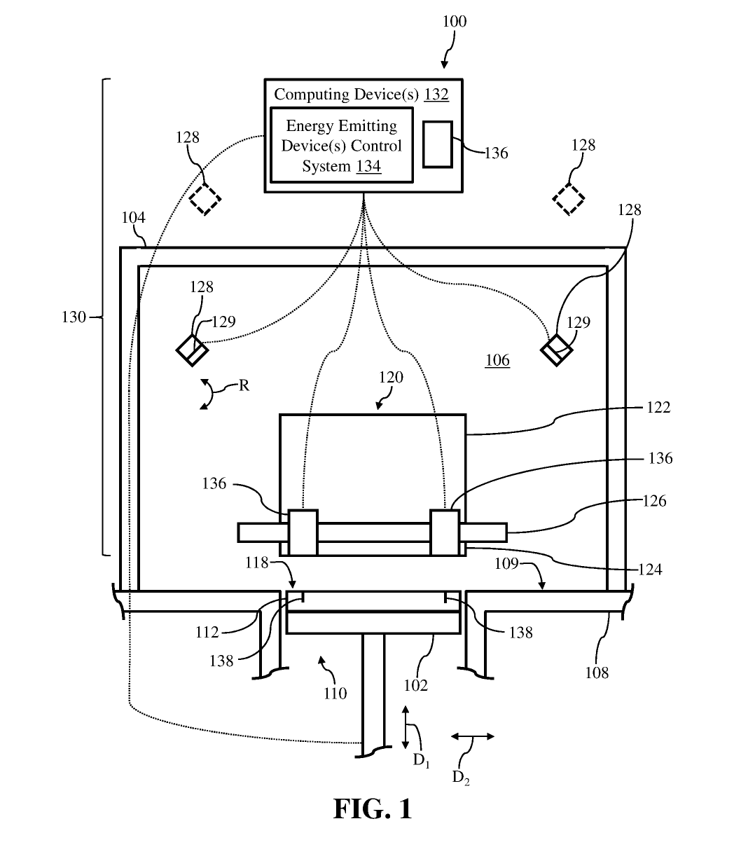

These and other embodiments are discussed below with reference to FIGS. 1-9. However, those skilled in the art will readily appreciate that the detailed description given herein with respect to these Figures is for explanatory purposes only and should not be construed as limiting.

FIG. 1 shows a front view of an additive manufacturing system 100. Specifically, FIG. 1 shows a front view of additive manufacturing system 100 with a portion of an enclosure or build chamber removed to exposed internal components and/or features of additive manufacturing system 100. As discussed in detail herein, additive manufacturing system 100 may include a calibration system configured to calibrate energy emitting device(s) of additive manufacturing system 100. Additive manufacturing system 100 including the calibration system and the process of calibrating the energy emitting device(s) of additive manufacturing system 100, as discussed herein, may significantly improve the quality and/or accuracy of a component built from powder material by additive manufacturing system 100.

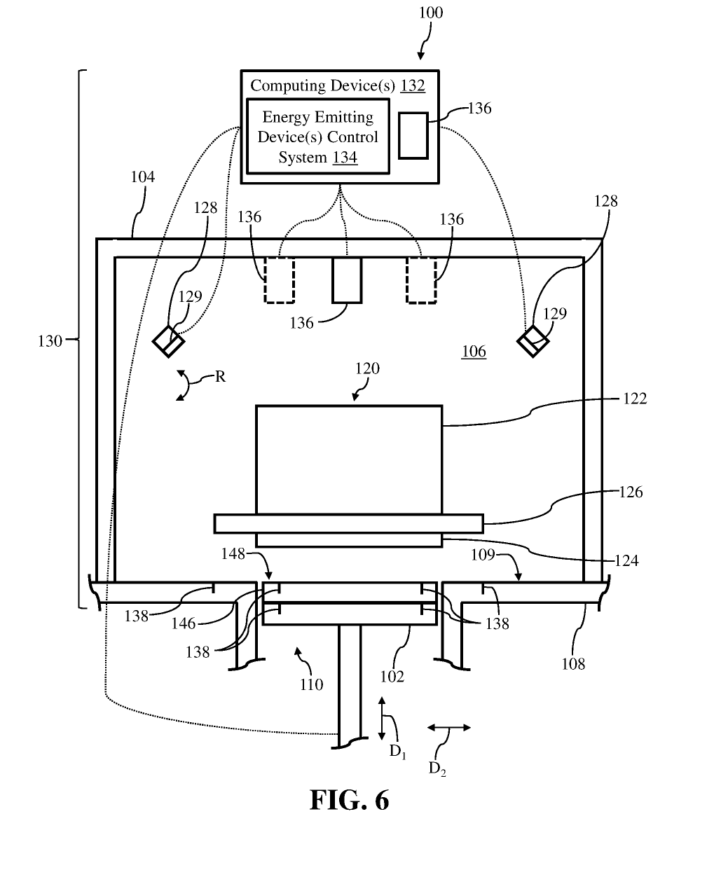

As shown in FIG. 1, additive manufacturing system 100 (hereafter, “AMS 100”) may include a movable build platform 102 (hereafter, “build platform 102”). Build platform 102 may be positioned within a build chamber 104 of AMS 100. That is, build platform 102 may be at least partially positioned or disposed within a chamber or cavity 106 of build chamber 104, such that build chamber 104 may substantially surround build platform 102. Additionally, build platform 102 may be positioned adjacent and/or within a support table 108 of AMS 100. As shown in FIG. 1, support table 108 may include an exposed surface 109 positioned within cavity 106 and an opening 110 configured to receive and/or substantially surround build platform 102. As discussed herein, support table 108 may receive, contact, and/or support various components of AMS 100. Additionally in a non-limiting example, support table 108 may be coupled to and/or may be included as part of build chamber 104, such that build chamber 104 and support table 108 substantially define cavity 106. Support table 108, and more specifically exposed surface 109 may be utilized in a calibration process, as discussed herein (see, FIG. 6).

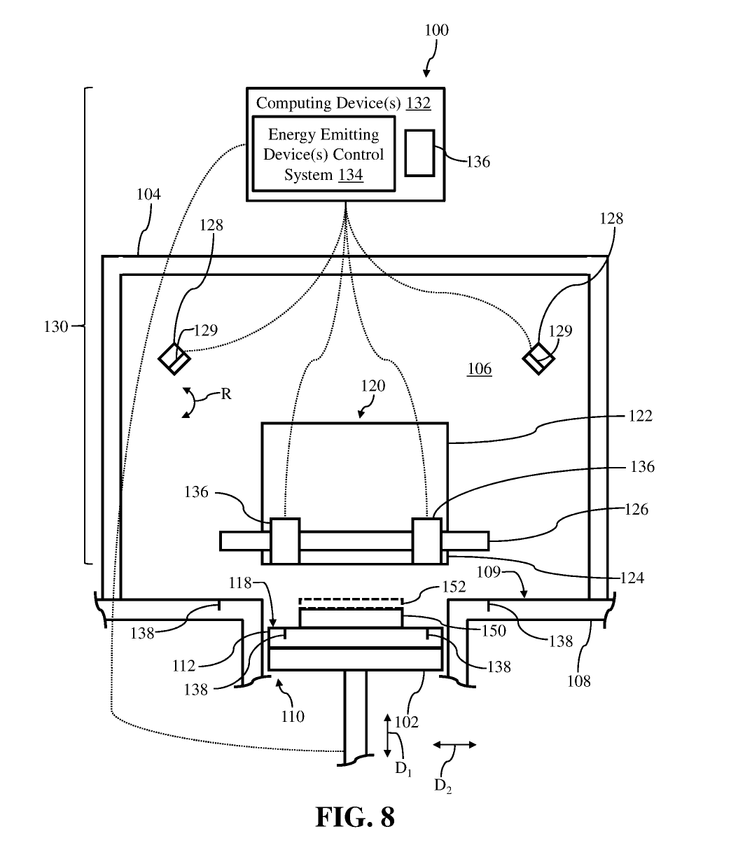

As shown in FIG. 1, build platform 102 may be configured to receive a build plate 112. Specifically, build plate 112 may be positioned directly on and/or above build platform 102 and may extend into and/or adjacent cavity 106. In a non-limiting example shown in FIG. 1, build platform 102 may be configured to move in various directions (D₁, D₂) for adjusting the height of build platform 102 and/or build plate 112. As discussed herein, build platform 102 may move in the various directions (D₁, D₂) during a building process performed by AMS 100 to build a component (see, FIG. 8) from a powder material (see, FIG. 8) on build plate 112. Additionally, build platform 102 may move in the various directions (D₁, D₂) during a calibration process performed by systems of AMS 100, as discussed herein. In non-limiting examples, build platform 102 may be configured to move in the directions (D₁, D₂) during a building process performed by AMS 100 by any suitable system, device and/or mechanism including, but not limited to, hydraulic and/or actuator systems. In another non-limiting example, build platform 102 may be coupled to and/or in electronic communication with a leveling system (not shown). The leveling system may be configured to move build platform 102 in the direction (D), as well as, adjust the tilt and/or inclination of build platform 102 to position or orient the build platform 102 to be substantially level, planarly aligned with other components of AMS 100 and/or to include a desired inclination for the calibration and/or component build processes, as discussed herein.

Build platform 102 may be formed from any suitable material that may receive and/or support the powder material and the component formed from the powder material, as discussed herein. Additionally, the size and/or geometry of build platform 102 of AMS 100 may be dependent on, at least in part, the amount of powder material used by AMS 100 to form the component, the size of the component, the geometry of the component formed by AMS 100, and/or the size of build plate 112 positioned directly on build platform 102.

Build chamber 104 may at least partially and/or substantially surround build platform 102 and build plate 112 positioned directly on build platform 102. Build chamber 104, along with support table 108, may be formed as any suitable structure and/or enclosure including build cavity 106 that may receive build platform 102, build plate 112 and/or additional components of AMS 100 that may be used to form a component. Build chamber 104 may be formed from any suitable material that may be capable of including and/or supporting the features of AMS 100. In non-limiting examples, build chamber 104 may be formed from metals, metal alloys, ceramics, polymers and other materials including similar physical, material and/or chemical characteristics. Additionally, the size and/or geometry of build chamber 104 may be dependent on, at least in part, the size and/or the geometry of the component formed by AMS 100.

Build plate 112 may be positioned on, retained on and/or releasably coupled to build platform 102 and may be used by AMS 100 to build components, as discussed herein. Build plate 112 may be positioned directly on, and releasably coupled to build platform 102 of AMS 100 using any suitable coupling technique and/or mechanism. For example, build plate 112 may be releasably coupled to build platform 102 using bolts, screws, clips, retention pins and the like. As a result of being releasably coupled to build platform 102, build plate 112 may move in various directions (D₁, D₂) along with build platform 102.

Build plate 112 may also include an exposed, build surface 118 that may receive powder material for building the component directly on build surface 118, as discussed herein. As shown in FIG. 1, build surface 118 may be exposed within cavity 106 of build chamber 104, and may be in substantial planar alignment, substantially level and/or substantially even with support table 108 of AMS 100 prior to building the component from the powder material (e.g., pre-build state). As discussed in a non-limiting example herein, aligning build surface 118 of build plate 112 with support table 108 of AMS 100 may aid in calibrating the energy emitting device(s) of AMS 100. Additionally, and as discussed herein, build plate 112 may include at least one reference mark formed on and/or in build surface 118 that may be used to calibrate the energy emitting device(s) of AMS 100.

Build plate 112 may be made from any suitable material capable of withstanding the processes for building a component using AMS 100. In non-limiting examples, build plate 112 may be formed from stainless steel, titanium, nickel, cobalt or iron alloys, aluminum or any other material having similar physical, material and/or chemical characteristics. Additionally, the size and/or geometry of build plate 112 of AMS 100 may be dependent on, at least in part, the amount of powder material used by AMS 100 to form the component, the size of the component, the geometry of the component formed by AMS 100, and/or the size of build platform 102 configured to receive and releasably couple build plate 112.

AMS 100 may also include a recoater device 120. As shown in FIG. 1, recoater device 120 may be positioned within cavity 106. Specifically, recoater device 120 of AMS 100 may be positioned within cavity 106, and/or may be surrounded by build chamber 104 and support table 108. Recoater device 120 may also be positioned above, and may be (at least partially) aligned with build platform 102, support table 108, and/or build plate 112 positioned directly on build platform 102. As discussed herein, recoater device 120 may include, be coupled to, and/or operably connected to various components, devices and/or systems that may be configured to deposit powder material on build surface 118 of build plate 112, for subsequent transformation (e.g., sintering) to build component layer-by-layer using AMS 100.

Recoater device 120 may include a powder material reservoir tank 122 (hereafter, “reservoir tank 122”). As shown in FIG. 1, reservoir tank 122 may be positioned within cavity 106 defined by build chamber 104, and may be positioned above build platform 102 and build plate 112, respectively. Reservoir tank 122 may be formed as any suitable component that may be configured to receive, contain and/or hold powder material (e.g., metal, polymer, ceramic and the like) that may be used in the build process to form build component on build plate 112, as discussed herein. In a non-limiting example, reservoir tank 122 may be formed from a tank, container, vessel, receptacle, chamber, hopper and/or the like. Additionally in a non-limiting example, reservoir tank 122 may be configured to deposit the powder material on build plate 112 for forming the build component layer-by-layer. Reservoir tank 122 may deposit the powder material on build plate 112 using any suitable material deposition component or device, and may deposit the powder material using any suitable material deposition technique or process.

As shown in FIG. 1, recoater device 120 may also include at least one blade 124. Blade 124 of recoater device 120 may be positioned below reservoir tank 122. That is, blade 124 may be positioned below reservoir tank 122, and may be positioned between build plate 112 and reservoir tank 122. In the non-limiting example, blade 124 may also be positioned above and directly adjacent build plate 112 positioned directly on build platform 102. Blade 124 may be coupled to and/or affixed to reservoir tank 122 via a blade holder 126 to form recoater device 120. That is, blade holder 126 may be positioned between, and affixed or coupled to each of reservoir tank 122 and blade 124, respectively, and may consequentially couple blade 124 to reservoir tank 122. As a result, and as discussed herein, when recoater device 120 moves and the powder material stored in reservoir tank 122 is deposited on build plate 112, blade 124 may also move with recoater device 120 and/or reservoir tank 122. Blade 124 of recoater device 120 may level the powder material deposited by reservoir tank 122 during the build process performed by AMS 100. Specifically, blade 124 may spread, level, smooth, and/or flatten the powder material after it is deposited by reservoir tank 122 to ensure the deposited layer of powder material includes a desired thickness before the powder material is transformed, as discussed herein. In non-limiting examples, blade 124 of recoater device 120 may be formed from any suitable component, and any suitable material, that may be configured to level the deposited powder material to form an even, desired thickness for the deposited powder material prior to material transformation. In non-limiting examples, blade 124 may be formed from ceramic material, stainless steel, rubber, sintered powder material, and/or may be formed as a brush including a plurality of bristles. Although only a single blade 124 is shown, it is understood that recoater device 120 may include more blades 124 and/or blade holders 126.

Recoater device 120 may also be coupled to a track system (not shown) of AMS 100. The track system may be configured to adjust a position of and/or move recoater device 120 within build chamber 104 of AMS 100, over build plate 112, during the component build process performed by AMS 100, as discussed herein. The track system may be formed as any suitable component, device and/or system that may be configured to adjust the position and/or move recoater device 120. For example, the track system may be formed as a four-post track system and cross-bar support that may be configured to move recoater device 120 in a direction in-and-out of the page, over build plate 112, during the component build process discussed herein. In other non-limiting examples, AMS 100 may include any suitable component and/or system configured to adjust the position of recoater device 120 when performing the component build process, as discussed herein. For example, recoater device 120 may be coupled and/or fixed to a movable armature that may adjust the position of recoater device 120 in the various required directions (e.g., directions (D₁, D₂), a direction in-and-out of the page) to perform the component build process, as discussed herein.

AMS 100 may also include at least one energy emitting device 128. As discussed herein, energy emitting device(s) 128 may be any device configured to perform a material transformation process (e.g., sintering, melting) on various powder materials (e.g., metal, polymer, ceramic and the like) used to form the component on build plate 112. As shown in FIG. 1, energy emitting device(s) 128 of AMS 100 may be positioned substantially above build platform 102 and/or build plate 112 positioned directly on build platform 102. Additionally as shown in FIG. 1, energy emitting device(s) 128 may be positioned above recoater device 120. In the non-limiting example shown in FIG. 1, energy emitting devices(s) 128 may be positioned within build chamber 104, and may be coupled to and/or fixed to build chamber 104. In another non-limiting example, energy emitting device(s) 128 may be positioned outside of and/or above build chamber 104 of AMS 100 (see, energy emitting device(s) 128 shown in phantom). Energy emitting device(s) 128 of AMS 100 may include at least one adjustable mirror 129. The position and/or inclination of mirror(s) 129 of energy emitting device(s) 128 may be (continuously) adjusted during the component build processes to direct and/or move the emitted energy (e.g., laser beam, electron beam) over build plate 112 to form the component, as discussed herein. In another non-limiting example, energy emitting device(s) 128 may be configured to at least partially rotate in a direction (R) in order to form component on build plate 112 by performing build process discussed herein. In additional non-limiting examples, energy emitting device(s) 128 may be coupled to a distinct track system (not shown) that may be configured to move energy emitting device(s) 128, individually, in various directions (e.g., directions (D₁, D₂), a direction in-and-out of the page) when performing build process discussed herein.

Energy emitting device(s) 128 may be any suitable device configured to and/or capable of forming component on build plate 112 from powder material. Specifically, energy emitting device(s) 128 may be configured to and/or capable of transforming the powder material (e.g., sintering, melting), layer-by-layer, to form a component, as discussed herein. In a non-limiting example shown in FIG. 1, energy emitting device(s) 128 may be any suitable laser or laser device configured to emit light capable of transforming the powder material. In other non-limiting examples (not shown), energy emitting device(s) 128 may include any other suitable radiant energy or irradiation device (e.g., electron beam) configured to transform the powder material including, but not limited to, a heat source, a radiation-emitting device, a microwave-emitting device and the like. Additionally, two energy emitting devices 128 are shown and discussed herein with respect to AMS 100. However, it is understood that the number of energy emitting devices of AMS 100 shown in the figures is merely illustrative. As such, AMS 100 may include more or fewer energy emitting device(s) 128 than the number depicted and discussed herein.

During the component build process, powder or granular material may be added to predetermined areas of build surface 118 of build plate 112 using recoater device 120. Specifically, reservoir tank 122 of recoater device 120 may move over (e.g., direction in-and-out of the page) build platform 102/build plate 112, and may deposit powder material on build surface 118 of build plate 112. Additionally, and substantially simultaneous to the deposition, blade 124 of recoater device 120 may also spread, level, smooth, and/or flatten the deposited powder material on build plate 112 to have a substantially planar surface and/or to include a predetermined, desired thickness. Once deposited and leveled by recoater device 120, the powder material may subsequently be transformed (e.g., sintered) by energy emitting device(s) 128 to form a layer of build component. Once the layer of powder material is transformed by energy emitting device(s) 128, build platform 102, and build plate 112 positioned directly on and coupled to build platform 102, may be adjusted and/or moved in at least a first direction (D₁), within opening 110, away from and/or further below recoater device 120. The deposition, leveling, material transformation, and build platform 102 adjustment process may be continuously performed to build component layer-by-layer. Once the component is built on build surface 118 of build plate 112, the component may be removed and build plate 112, build plate 112 may be reused by AMS 100 and/or undergo another build process, as discussed herein, to have distinct component built on build surface 118.

As shown in FIG. 1, AMS 100 may also include a calibration system 130. As discussed herein, calibration system 130, and its various components, may be operably connected to portions, components, devices, and/or systems of AMS 100 (e.g., movable build platform 102, energy emitting device(s) 128, and so on) to calibrate energy emitting device(s) 128. Additionally as discussed in detail herein, calibration system 130 and the processes of calibrating energy emitting device(s) 128 of AMS 100, and specifically the path of the energy generated by energy emitting device(s) 128 for transforming the powder material, using calibration system 130 may improve the quality and/or accuracy of a component built from powder material by AMS 100 by ensuring the energy emitting device(s) 128 is positioned and/or oriented within or adjacent AMS 100 to emit energy in a desired location (e.g., over powder material) prior to and during the build process.

Calibration system 130 may include at least one computing device(s) 132 configured to calibrate energy emitting device(s) 128. Computing device(s) 132 may be hard-wired, wirelessly and/or operably connected to and/or in communication with various components of AMS 100 via any suitable electronic and/or mechanic communication component or technique. Specifically, computing device(s) 132 of calibration system 130 may be in electrical communication and/or operably connected to movable build platform 102, energy emitting device(s) 128 and/or at least one measurement device of AMS 100, discussed herein. Computing device(s) 132, and its various components discussed herein, may be a single stand-alone system that functions separate from an operations system of AMS 100 (e.g., computing device) (not shown) that may control and/or adjust at least a portion of operations and/or functions of AMS 100, and its various components (e.g., build platform 102, recoater device 120, energy emitting device(s) 128, and so on). Alternatively, computing device(s) 132 and its components may be integrally formed within, in communication with and/or formed as a part of a larger control system of AMS 100 (e.g., computing device)(not shown) that may control and/or adjust at least a portion of operations and/or functions of AMS 100, and its various components.

In various embodiments, computing device(s) 132 can include an energy emitting device(s) control system 134 (hereafter, “control system 134”) for calibrating energy emitting device(s) 128. As a result of computing device(s) 132 being in operable communication with movable build platform 102, energy emitting device(s) 128, and/or measurement device(s), control system 134 may also be in electronic communication and/or operably connected to movable build platform 102, energy emitting device(s) 128, and/or measurement device(s) of AMS 100, and may be configured to operate and/or move movable build platform 102, and/or energy emitting device(s) 128. That is, and as discussed herein, computing device(s) 132 and/or control system 134 may be configured to calibrate energy emitting device(s) 128 by adjusting a position of movable build platform 102, energy emitting device(s) 128, and/or mirror(s) 129 of energy emitting device(s) 128, based on test marks formed by energy emitting device(s) 128 and reference marks formed on reference surface(s) (e.g., exposed surface 109, build surface 118, surface of build platform 102, calibration surface (see, FIG. 6), and so on) of AMS 100, to improve the quality and/or accuracy of a component built from powder material by AMS 100.

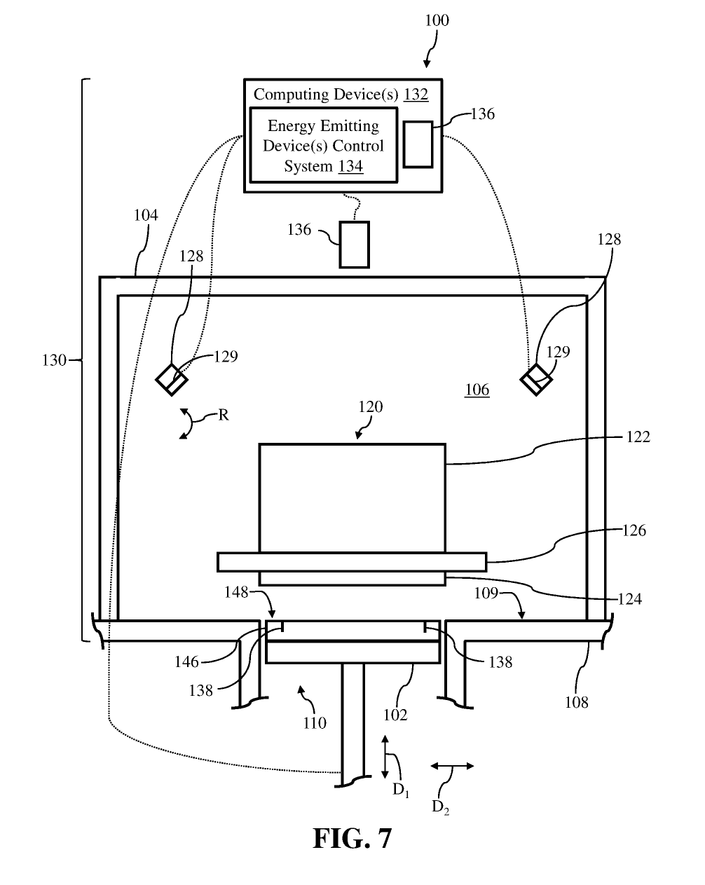

Additionally, calibration system 130 may also include at least one measurement device 136. Measurement device(s) 136 may be in electronic communication and/or operably connected to computing device(s) 132 and/or control system 134, and may be configured to provide measured data to computing device(s) 132 and/or control system 134 to be used in the calibration process discussed herein. Additionally, measurement device(s) 136 may be positioned within and/or adjacent AMS 100 to determine an actual location of a test mark formed by energy emitting device(s) 128 and a desired location of a reference mark, as discussed herein. In a non-limiting example, measurement device(s) 136 may be positioned within cavity 106 defined by build chamber 104 and/or support table 108. Additionally in the non-limiting example shown in FIG. 1, measurement device(s) 136 may be positioned on, and/or coupled to recoater device 120, and more specifically, to blade holder 126 of recoater device 120. As a result of being coupled to recoater device 120, measurement device(s) 136 may also be positioned substantially above and/or in substantial alignment with build plate 112. In other non-limiting examples discussed herein, measurement device(s) 136 may be positioned in other areas or portions of build chamber 104 of AMS 100 (see, FIG. 6), or alternatively, may be positioned above and/or outside of cavity 106 defined by build chamber 104 (see, FIG. 7).

Measurement device(s) 136 of calibration system 130 may be any suitable measurement device, component, or sensor configured to detect and/or determine an actual location of a test mark formed by energy emitting device(s) 128 and/or a desired location of a reference mark formed on reference surfaces of AMS 100, as discussed herein. For example, and as shown in FIG. 1, measurement device(s) 136 coupled to recoater device 120, and more specifically blade holder 126 of recoater device 120, may be a camera or camera system. The camera or camera system forming measurement device(s) 136 may be a video camera system configured to capture video images of the test mark and/or the reference mark formed on build surface 118 (e.g., reference surface) build plate 112, as discussed herein. In other non-limiting examples, the camera or camera system forming measurement device(s) 136 may be a still camera or photography camera configured to capture photographic images of the test mark and/or the reference mark formed on build surface 118 of build plate 112.

In other non-limiting examples, measurement device(s) 136 may formed or configured as a surface scanner sensor or device. Scanner sensor forming measurement device(s) 136 may scan exposed or build surface 118 of build plate 112 to detect test marks and reference marks, and specifically, identify the locations of the test marks and reference marks on build surface 118 for calibrating energy emitting device(s) 128, as discussed herein. Scanner sensors may detect the marks on build surface 118 of build plate 112 by, for example, detecting and/or recognizing changes in color, surface smoothness, and/or other changes in the physical characteristics of build surface 118 of build plate 112 caused by test marks formed by energy emitting device(s) 128 and/or reference marks. In other non-limiting examples, measurement device(s) 136 may include line scanner sensor(s) or systems, Infrared camera systems, and camera and illumination systems.

In the non-limiting example shown in FIG. 1, two measurement device(s) 136 are shown. However, in other non-limiting examples, calibration system 130 of AMS 100 may include more or fewer measurement device(s) 136 (see, FIGS. 6 and 7), so long as measurement device(s) 136 may be configured to provide computing device(s) 132, and/or control system 134, with information or data relating the test marks formed on build surface 118 of build plate 112 by energy emitting device(s) 128, as discussed herein. That is, the number of measurement device(s) 136 shown in FIG. 1 is merely illustrative and non-limiting.

The calibration process for calibrating energy emitting device(s) 128 of AMS 100 may now be discussed. In a non-limiting example, the calibration process for calibrating energy emitting device(s) 128 may be performed at a “pre-build” stage. The pre-build stage may be before a powder material is deposited on build surface 118 of build plate 112 by recoated device 120, and before any portion of component is built on build surface 118 of build plate 112 by energy emitting device(s) 128. By performing the calibration process for calibrating energy emitting device(s) 128 in the pre-build stage (e.g., before beginning to build the component from powder material on build plate 112), it may ensure that energy emitting device(s) 128 is positioned or oriented within or adjacent AMS 100, and/or configured to emit energy in an exact, desired location (e.g., over powder material) during the build process. As discussed herein, calibrating energy emitting device(s) 128 may in turn improve the build efficiency and/or quality of the component formed by AMS 100.

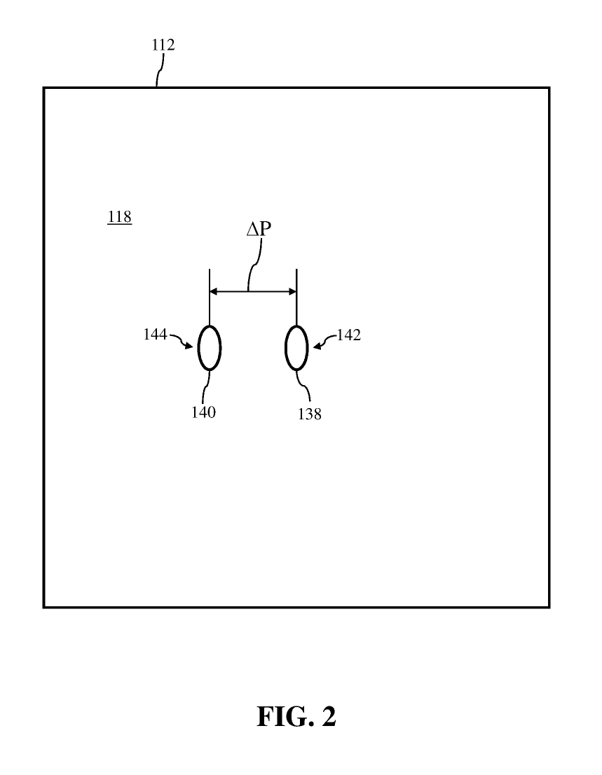

Turning to FIG. 2, and with continued reference to FIG. 1, a portion of build plate 112 of AMS 100 is shown. In the non-limiting example discussed herein, the reference surface, including reference marks, used to calibrate energy emitting device(s) 128 may be build surface 118 of build plate 102. However, in other non-limiting examples, the reference surface may refer to and/or may include other exposed surfaces aligned with and/or positioned adjacent measurement device(s) 136 of calibration system 130. Additional non-limiting examples of the reference surface, including reference marks, may include exposed surface 109 of support table 108 (see, FIGS. 6 and 8), a surface of movable build platform 102 (where build plate 112 is not positioned on build platform 102) (see, FIG. 6), and/or calibration surface of a calibration plate (see, FIG. 6).

As shown in FIGS. 1 and 2, build plate 112 may include a reference mark 138 and test mark 140 formed therein. More specifically, build plate 112 may include reference mark 138 and test mark 140 formed in and/or on exposed build surface 118 (e.g., reference surface). The number of reference marks 138 and/or test marks 140 formed in build surface 118 of build plate 112 may be dependent, at least in part, on the number of energy emitting device(s) 128 included in AMS 100, the position of energy emitting device(s) 128 within AMS 100, and/or the movement capabilities (e.g., directions (D₁, D₂), a direction in-and-out of the page) of energy emitting device(s) 128 within AMS 100. In the non-limiting example shown in FIG. 1, AMS 100 may include two distinct energy emitting devices 128. As such, and as shown in the non-limiting example, two distinct reference marks 138 may be formed on build surface 118 of build plate 112. Although one single reference mark 138 and test mark 140 are shown and discussed herein with respect to performing the calibration process on energy emitting device(s) 128, it is understood that the process for calibrating energy emitting device(s) 128 may be performed on all energy emitting device(s) 128 of AMS 100 using as any or all reference marks 128 and/or test marks 140 formed on build surface 118 of build plate 112.

Reference mark 138 may be formed and/or physically made directly on and/or in exposed, build surface 118 of build plate 112. Reference mark 138 may be formed at a predetermined, desired location 142 on build surface 118 of build plate 112. The predetermined, desired location 142 may be determined by computing device(s) 132 and/or control system 134 of calibration system 130, and may be used to calibrate energy emitting device(s) 128. Additionally, and similar to the number of marks 138, formed on build plate 112, the predetermined, desired location 142 for reference mark 138 may be based on, at least in part, on the number of energy emitting device(s) 128 included in AMS 100, the position of energy emitting device(s) 128 within AMS 100, the path or movement capabilities of the energy emitted by energy emitting device(s) 128 as determined by mirror(s) 129, and/or the movement capabilities (e.g., directions (D₁, D₂), a direction in-and-out of the page) of energy emitting device(s) 128 within AMS 100. Reference mark 138 may be formed at the predetermined, desired location 142 on build surface 118 of build plate 112 using any conventional measuring and/or machining systems and/or techniques. For example, after computing device(s) 132 and/or control system 134 of calibration system 130 determine the position of predetermined, desired location 142, computing device(s) 132 and/or control system 134 may communicate the position to a user (e.g., via print out), who may manually measure the location of predetermined, desired location 142, and manually create reference mark 138 on build surface 118, prior to positioning build plate 112 on build platform 102. Alternatively, computing device(s) 132 and/or control system 134 may communicate the position to various distinct systems or machines, including a coordinate measuring machine and a milling machine, which may in turn measure, determine and/or locate the predetermined, desired location 142 on build plate 112, and subsequently machine and/or create reference mark 138 on build surface 118, prior to positioning build plate 112 on build platform 102.

Additionally as shown in FIG. 2, build plate 112 may include test mark 140. Test mark 140 may be formed directly in and/or on build surface 118 (e.g., reference surface) of build plate 112. In a non-limiting example, test mark 140 may be formed by energy emitting device(s) 128 of AMS 100. More specifically, a single test mark 140 may be formed in build surface 118 by a single energy emitting device 128 by exposing build surface 118 of build plate 112 to energy generated and/or emitted by energy emitting device 128. Additionally, computing device(s) 132 and/or control system 134 of calibration system 130 may communicate predetermined, desired location 142 for test mark 140 to energy emitting device(s) 128, and may subsequently instruct and/or operate energy emitting device(s) 128 to form test mark 140 at predetermined, desired location 142. Energy emitting device(s) 128 may then in turn form test mark 140 on build surface 118 of build plate 112.

Once test mark 140 is formed on build surface 118 of build plate 112, measurement device(s) 136 of calibration system 130 may determine an actual location 144 of test mark 140. That is, measurement device(s) 136 of calibration system 130 may view, capture images and/or scan build surface 118 of build plate 112 to determine an actual location 144 of test mark formed on build surface 118 of build plate 112. In the non-limiting example shown in FIG. 1, and as discussed herein, measurement device(s) 136 may be positioned on and/or coupled to recoater device 120. As such, after energy emitting device(s) 128 form test mark 140 on build plate 112, recoater device 120 may move or travel over build plate 112 so measurement device(s) 136 may view, capture images and/or scan build surface 118 of build plate 112 to determine actual location 144 of test mark formed on build surface 118 of build plate 112. Once actual location 144 of test mark 140 is determined, measurement device(s) 136 may provide actual location 144 of test mark 140 to computing device(s) 132 and/or control system 134 of calibration system 130 to determine if energy emitting device(s) 128 require calibration.

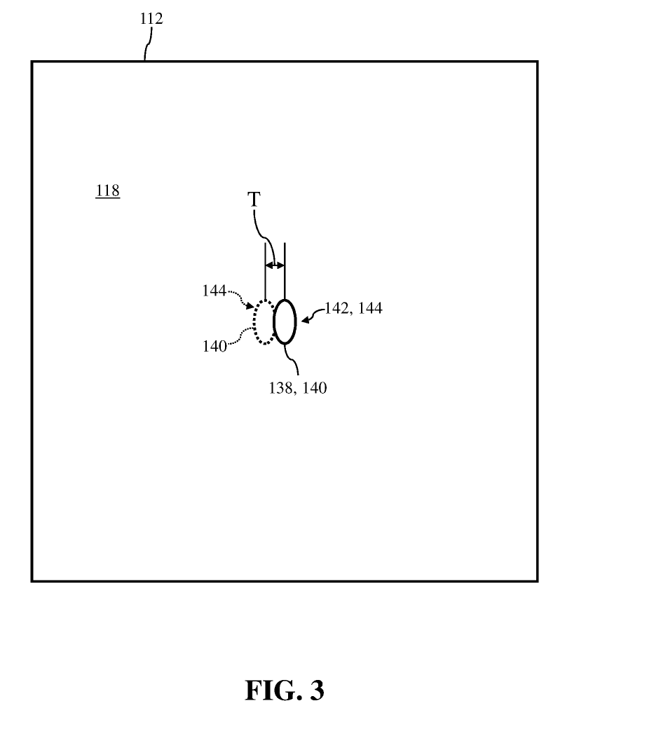

If it is determined by calibration system 130 that actual location 144 of test mark 140 matches, is identical and/or formed in substantially the same area as predetermined desired location 142 of reference mark 138 (see, FIG. 3), than calibration system 130 may determine energy emitting device(s) 128 is positioned and/or oriented in a desired and/or ideal position and/or orientation within AMS 100, and/or mirror(s) 129 of energy emitting device(s) 128 are directing the generated energy to an accurate, desired location within AMS 100. The desired and/or ideal position and/or orientation of energy emitting device(s) 128, and/or desired path for emitted energy determined by mirror(s) 129 may ensure energy emitting device(s) 128 can emit energy in an exact, desired location (e.g., over powder material) during the build process. As such, calibration system 130 may not calibrate energy emitting device(s) 128.

However, if it is determined that actual location 144 of test mark 140 on build surface 118 (e.g., reference surface) of build plate 112 differs from predetermined, desired location 142 of reference mark 138, than calibration system 130 may calibrate energy emitting device(s) 128. That is, computing device(s) 132 and/or control system 134 of calibration system 130 may receive the data and/or images of build surface 118 of build plate 112 captured by measurement device(s) 136, and determine if the actual location 144 of test mark 140 on build surface 118 of build plate 112 differs from predetermined, desired location 142 of reference mark 138. Once computing device(s) 132 and/or control system 134 determines the actual location 144 of test mark 140 differs from predetermined, desired location 142 of reference mark 138, energy emitting device(s) 128 may be calibrated by computing device(s) 132 and/or control system 134. Calibrating energy emitting device(s) 128 may include adjusting energy emitting device(s) 128 within AMS 100. In non-limiting examples discussed herein, calibration system 130 may adjust energy emitting device(s) 128 during calibration by altering a position of mirror(s) 129 of energy emitting device(s) 128 and/or altering the position of energy emitting device(s) 128 until actual location 144 of test mark 140 formed on exposed, build surface 118 of build plate 112 is substantially identical to predetermined, desired location 142 of reference mark 138 formed on build surface 118 of build plate 112.

To further aid in the calibration of energy emitting device(s) 128, and as shown in FIG. 2, computing device(s) 132 and/or control system 134 of calibration system 130 operably connected to measurement device(s) 136 may determine a positional deviation (ΔP) between test mark 140 and reference mark 130. Positional deviation (ΔP) may be determined by comparing and/or measuring a distance between actual location 144 of test mark 140 formed by energy emitting device(s) 128 on build surface 118 (e.g., reference surface) of build plate 112, and predetermined, desired location 142 for reference mark 138. Additionally, determining positional deviation (ΔP) may include determining the direction in which test mark 140 is shifted and/or displaced with respect to reference mark 138. Using determined positional deviation (ΔP), calibration system 130 may determine and/or calculate the exact movement, and/or positional/orientation adjustment or alteration to calibrate energy emitting device(s) 128 such that actual location 144 of test mark 140 is identical to predetermined, desired location 142 of reference mark 138 (see, FIG. 3). Additionally, the positional deviation (ΔP) for each energy emitting device(s) 128 may be determined and compared to each other to aid in the calibration process as discussed herein.

Calibration system 130 may adjust energy emitting device(s) 128 during the calibration process using various components of AMS 100. In a non-limiting example shown in FIG. 1, calibration system 130, and more specifically computing device(s) 132 and/or control system 134, may be in communication with and/or operably connected to energy emitting device(s) 128, and more specifically, mirror(s) 129 of energy emitting device(s) 128. In response to determining that calibration system 130 should calibrate energy emitting device(s) 128, computing device(s) 132 and/or control system 134 may alter a position of mirror(s) 129 of energy emitting device(s) 128 until actual location 144 of test mark 140 formed on build surface 118 of build plate 112 is substantially identical to predetermined, desired location 142 of reference mark 138. Altering the position of mirror(s) 129 of energy emitting device(s) 128 may include displacing, moving or adjusting a position of mirror(s) 129 of energy emitting device(s) 128, and/or adjusting an inclination of mirror(s) 129 of energy emitting device(s) 128. By altering the position of mirror(s) 129 of energy emitting device(s) 128, the path or beam of emitted energy (e.g., laser beam, electron beam) by energy emitting device(s) 128 may be adjusted and/or changed to a desired path or position (e.g., predetermined, desired location 142) during the building process, as discussed herein.

In another non-limiting example shown in FIG. 1, calibration system 130, and more specifically computing device(s) 132 and/or control system 134, may be in communication with and/or operably connected to energy emitting device(s) 128. In response to determining that calibration system 130 should calibrate energy emitting device(s) 128, computing device(s) 132 and/or control system 134 may adjust energy emitting device(s) 128 by altering the position and/or moving energy emitting device(s) 128 in various directions (e.g., directions (D₁, D₂), a direction in-and-out of the page) using, for example, a track system (not shown), and/or rotating energy emitting device(s) 128 in a direction (R). That is, in order to alter the position of energy emitting device(s) 128 during the calibration process, computing device(s) 132 and/or control system 134 may displace energy emitting device(s) 128 (e.g., directions (D₁, D₂)), and/or rotate energy emitting device(s) in a direction (R). In another non-limiting example shown in FIG. 1, calibration system 130, and more specifically computing device(s) 132 and/or control system 134, may be in communication with and/or operably connected to movable build platform 102. In response to determining that calibration system 130 should calibrate energy emitting device(s) 128, computing device(s) 132 and/or control system 134 may calibrate energy emitting device(s) by adjusting the position and/or moving build platform 102, and build plate 112 positioned thereon, in various directions (e.g., directions (D₁, D₂), a direction in-and-out of the page).

Calibrating energy emitting device(s) 128, and more specifically altering the position of energy emitting device(s) 128 of AMS 100 and/or the position of mirror(s) 129 of energy emitting device(s) 128, may ensure that energy emitting device(s) 128 is emitting energy in an specific, desired location (e.g., over powder material) during the build process. Additionally by calibrating energy emitting device(s) 128, the powder material deposited on build plate 112 may be completely and/or accurately transformed by energy emitting device(s) 128 which may be calibrated to emit energy in the exact locations including the powder material. This may ultimately improve build quality, build accuracy, operational characteristics, and/or operational life of the component build by AMS 100.

In another non-limiting example shown in FIG. 3, energy emitting device(s) 128 may be calibrated such that actual location 144 of test mark 140 formed on build surface 118 of build plate 112 is substantially close and/or proximate to predetermined, desired location 142 of reference mark 138. That is, in another non-limiting example, energy emitting device(s) 128 may be calibrated such that actual location 144 of test mark 140 (shown in phantom) may be within a tolerance distance (T) from predetermined, desired location 142 of reference mark 138; but not exactly in the same location as predetermined, desired location 142. Although not exactly aligned with and/or in the same location as predetermined, desired location 142, test mark 140 formed within the tolerance distance (T) of predetermined, desired location 142 may still improve build quality, build accuracy, operational characteristics, and/or operational life of the component build by AMS 100, as discussed herein.

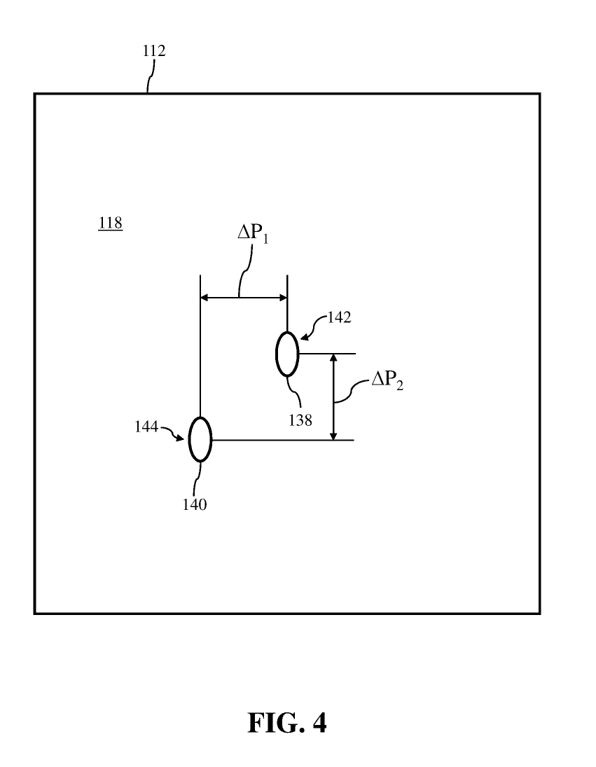

FIG. 4 shows another, non-limiting example of build plate 112 including reference mark 138 and test mark 140. Distinct from the example shown in FIG. 2 which depicted test mark 140 in partial alignment (e.g., horizontal alignment) with reference mark 138, test mark 140 shown in FIG. 4 may be displaced in two directions with respect to reference mark 138. More specifically, actual location 144 of test mark 140 may be distinct and/or separated from predetermined, desired location 142 of reference mark 138 in two distinct directions. Although displaced in two directions, calibration system 130 may be configured to determined positional deviations (ΔP) between test mark 140 and reference mark 138. As similarly discussed herein, a first positional deviation (ΔP₁) may be determined by comparing and/or measuring a distance between actual location 144 of test mark 140 formed by energy emitting device(s) 128 on build surface 118 of build plate 112, and predetermined, desired location 142 for reference mark 138 in a first direction. Additionally, a second positional deviation (ΔP₂) may be determined by comparing and/or measuring a distance between actual location 144 of test mark 140 formed by energy emitting device(s) 128 on build plate 112, and predetermined, desired location 142 for reference mark 138 in a second direction, substantially perpendicular to the first direction relating to the first positional deviation (ΔP₁). Determining both positional deviations (ΔP₁, ΔP₂) may aid in the calibration of energy emitting device(s) 128.

Although one test mark 140 is shown to include multiple positional deviations (ΔP₁, ΔP₂), it is understood that multiple test marks 140 may be formed on build surface 118 of build plate 112. Each of these multiple test marks 140 may be analyzed in a similar manner as discussed herein to determine positional deviations (ΔP₁, ΔP₂), to aid in the calibration of energy emitting device(s) 128. That is, multiple test marks 140 may be formed on build surface 118 of build plate 112 by energy emitting device(s) 128, and positional deviations (ΔP₁, ΔP₂) for each test mark 140 may be determined in order to calibration energy emitting device(s) 128, as discussed herein.

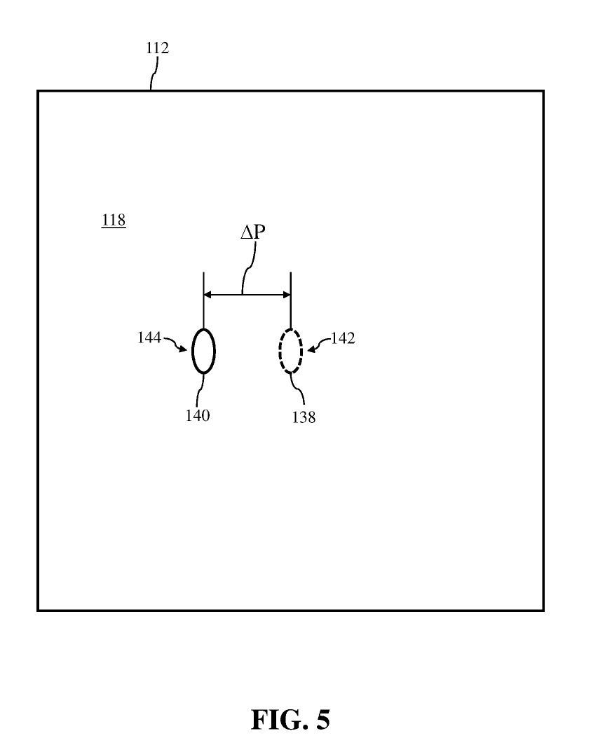

FIG. 5 shows an additional non-limiting example of build plate 112 including reference mark 138 and test mark 140. In the non-limiting example shown in FIG. 5, reference mark 138 shown in phantom may not physically be made, formed and/or created in build plate 112. That is, and distinct from reference mark 138 shown in FIG. 2, predetermined, desired location for reference mark 138 may be determined and/or calculated by computing device(s) 132 and/or control system 134 of calibration system 130, but reference mark 138 may not physically be formed on build surface 118 of build plate 112. Rather in the non-limiting example, information and/or data relating to the calculated, predetermined, desired location for reference mark 138 may be provided to measurement device(s) 136 and/or maintained by computing device(s) 132 and/or control system 134 of calibration system 130. Once test mark 140 is formed on build surface 118 of build plate 112, actual location 144 of test mark 140 may be determined and/or detected using measurement device(s) 136. Knowing actual location 144 of test mark 140, and having determined or calculated coordinates on build plate 112 for predetermined, desired location 142 for reference mark 138, computing device(s) 132 and/or control system 134 of calibration system 130 may calibrate energy emitting device(s) 128 as similarly discussed herein (e.g., actual location 144≠predetermined, desired location 142, positional deviation (ΔP), adjusting position of energy emitting device(s) 128 and/or mirror(s) 129, and so on).

FIGS. 6 and 7 show front views of various non-limiting examples of AMS 100. In the various non-limiting examples shown in FIGS. 6 and 7, calibration system 130 may include calibration plate 146 in place of build plate 112. Calibration plate 146 may be used by calibration system 130 and/or AMS 100 for calibrating energy emitting device(s) 128, as discussed herein. Additionally in the non-limiting examples, AMS 100 may include measurement device(s) 136 of calibration system 130 positioned in distinct locations of AMS 100, and/or calibration system 130 may include distinct numbers of measurement device(s) 136 as discussed herein with respect to FIG. 1. The distinctions in these components of AMS 100, as well as, the distinction in performing the calibration process for these non-limiting examples are discussed in detail herein. It is understood that similarly numbered and/or named components may function in a substantially similar fashion. Redundant explanation of these components has been omitted for clarity.

As shown in FIGS. 6 and 7, AMS 100 may include calibration plate 146. More specifically in the non-limiting example, calibration system 130 of AMS 100 may include calibration plate 146 positioned directly on movable build platform 102. As such, and distinct from the non-limiting example shown in FIG. 1, calibration plate 146 may replace build plate 112 during the calibration process performed by calibration system 130 discussed herein. In other non-limiting examples (not shown), calibration plate 146 may be positioned directly on build plate 112 and/or may be positioned on exposed surface 109 of support table 108.

As shown in FIGS. 6 and 7, calibration plate 146 may include calibration surface 148. Similar to build plate 112, and specifically build surface 118, reference marks 138 may be formed directly in and/or directly on calibration surface 148 of calibration plate 146. In non-limiting examples, calibration plate 146 may be used during a pre-build stage in a similar manner or fashion as build plate 112 for calibrating energy emitting device(s) 128. That is, a test mark 140 may be formed on calibration surface 148 (e.g., reference surface) of calibration plate 146, and measurement device(s) 136, computing device(s) 132 and/or control system 134 may determine if actual location 144 of test mark 140 differs from predetermined, desired location 142 of reference mark 138 in order to calibrate energy emitting device(s) 128. Once energy emitting device(s) 128 is calibrated by performing the calibration processes using calibration plate 146, calibration plate 146 may be removed from build platform 102 and/or may be replaced by build plate 112 so the component may be formed by AMS 100.

FIG. 6 also shows additional components of AMS 100 including reference marks 138. That is, the non-limiting example of AMS 100 of FIG. 6 shows reference marks 138 formed on exposed surface 109 of support table 108, and a surface of build platform 102, in addition to those reference marks 138 formed on calibration surface 148 of calibration plate 146. As discussed herein, each surface including the reference marks 138 shown in FIG. 6 may be considered a reference surface, and may be utilized to calibrate energy emitting device(s) 128, as discussed herein. That is, exposed surface 109 of support table 108 including reference marks 138 may the reference surface used by calibration system 130 for calibrating energy emitting device(s) 128. Additionally, where AMS 100 does not include build plate 112 (see, FIG. 1) or calibration plate 146, the surface of build platform 102 including reference marks 138, as shown in FIG. 6, may be used by calibration system 130 for calibrating energy emitting device(s) 128, as discussed herein.

FIGS. 6 and 7, also show non-limiting examples of calibration system 130 including various numbers of measurement device(s) 136. More specifically, calibration system 130 shown in FIG. 6 includes one actual measurement device 136 and two optional measurement device(s) 136 (shown in phantom). Additionally, calibration system 130 shown in FIG. 7 depicts a single measurement device 136. As discussed herein, the number of measurement device(s) 136 shown in the figures is merely illustrative and non-limiting.

Additionally, the position of measurement device(s) 136 of AMS 100 shown in FIGS. 6 and 7 may vary. That is, and with comparison to FIG. 1 showing measurement device(s) 136 coupled to recoater device 120, measurement device(s) 136 of calibration system 130 depicted in the non-limiting examples in FIGS. 6 and 7 may be positioned in distinct areas of AMS 100. For example, and as shown in FIG. 6, measurement device(s) 136 may be positioned within cavity 106 formed by build chamber 104, and may be positioned substantially above build platform 102, calibration plate 146, and recoater device 120, respectively. Additionally, in the non-limiting example shown in FIG. 6, measurement device(s) 136 may be coupled to and/or affixed to build chamber 104 of AMS 100. In another non-limiting example shown in FIG. 7, measurement device 136 may be positioned outside of cavity 106 and/or above build chamber 104 of AMS 100. That is, measurement device 136 may be positioned above build platform 102, calibration plate 146, recoater device 120, and build chamber 104, respectively. Although positioned outside of cavity 106 and/or above build chamber 104, measurement device 136 of calibration system 130 shown in FIG. 7 may be configured to and/or capable of viewing calibration plate 146 and determining actual location 144 of test mark 140 for calibrating energy emitting device(s) 128, as discussed herein.

In other non-limiting examples, calibration system 130 of AMS 100 may perform the calibration process at a mid-build stage in a substantially similar manner as when performing the calibration process at the pre-build stage, as discussed herein. For example, as shown in FIG. 8, calibration system 130 may calibrate energy emitting device(s) 128 of AMS 100 at the mid-build stage by performing similar processes as those performed to calibrate energy emitting device(s) 128 at the pre-build stage. For example, and as discussed herein with respect to FIG. 1, calibration system 130, and its various components, may calibrate energy emitting device(s) 128 during the mid-build stage by determining actual location 144 of test mark 140 formed on build plate 112, comparing actual location 144 of test mark 140 with predetermined, desired location 142 of reference mark 138 formed on build plate 112, and adjusting energy emitting device(s) 128.

However, distinct from the pre-build stage, a portion of component 150 may already be formed on build surface 118 of build plate 112 in the mid-build stage. As shown in FIG. 8, component 150 may not be built over, may not cover and/or may not obstruct reference marks 138 formed on build surface 118 (e.g., reference surface) of build plate 112. Additionally, the calibration process may be performed after all previously deposited powder material is removed from build surface 118 and/or before a subsequent layer of powder material 152 (shown in phantom) is deposited on component 150 in order to maintain the exposure and/or visibility of reference marks 138 formed on build surface 118 of build plate 112. As a result of the exposure and/or visibility of reference marks 138 on build surface 118 of build plate 112, the calibration process performed by calibration system 130 may be performed in the mid-build stage. In another non-limiting example, calibration system 130 may use reference marks 138 formed on exposed surface 109 (e.g., reference surface) of support table 108 in the mid-build stage for calibrating energy emitting device(s) 128. The calibration process for calibrating energy emitting device(s) 128 may be performed before every new layer of powder material 152 is deposited, or alternatively, after a plurality of layers of powder material 152 are deposited and subsequently transformed.

By performing the calibration process for calibrating energy emitting device(s) 128 in the mid-build stage, it may ensure that energy emitting device(s) 128 is emitting energy in an exact, desired location (e.g., over powder material) throughout the entire build process. Alternatively, performing the calibration process for calibrating energy emitting device(s) 128 in the mid-build stage may determine that energy emitting device(s) 128 needs to be recalibrated (mid-build) to ensure energy emitting device(s) 128 is emitting energy in an exact, desired location. This may in turn improve the build quality, build accuracy, operational characteristics, and/or operational life of component 150 built by AMS 100, as similarly discussed herein.

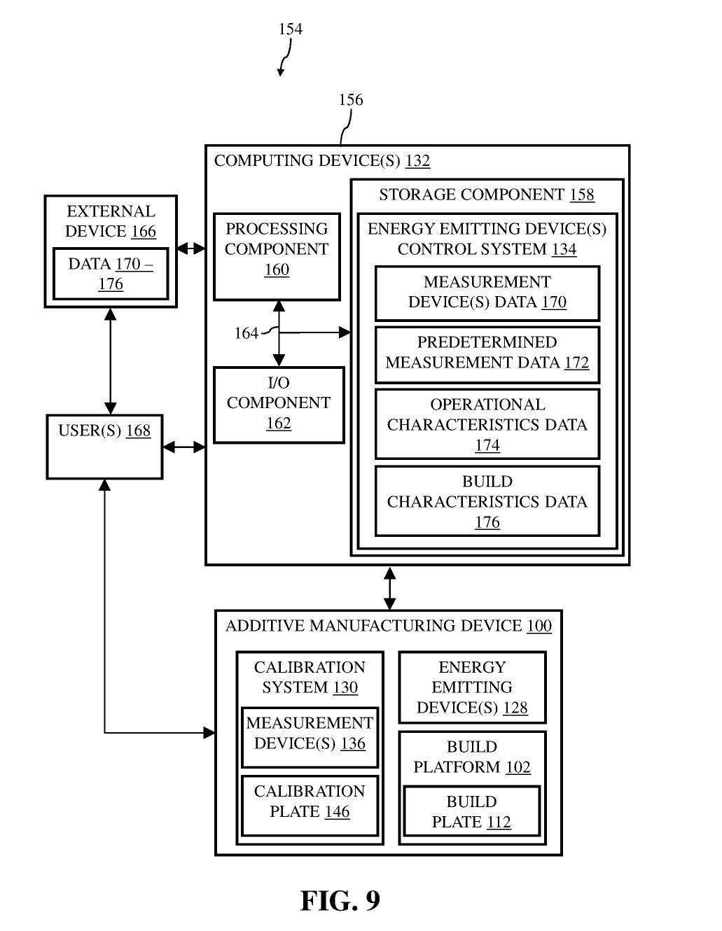

FIG. 9 shows an illustrative environment 154. To this extent, environment 154 includes computer infrastructure 156 that can perform the various process steps described herein for calibrating energy emitting device(s) 128 of AMS 100 by adjusting energy emitting device(s) 128 (see, FIG. 1). In particular, computer infrastructure 156 is shown including computing device(s) 132 that comprises energy emitting device(s) control system 134 (hereafter, “control system 134”), which enables computing device(s) 132 to calibrate energy emitting device(s) 128 of AMS 100 by performing one or more of the process steps of the disclosure.

Computing device(s) 132 is shown including a storage component 158 (e.g., non-transitory computer readable storage medium), a processing component 160, an input/output (I/O) component 162, and a bus 164. Further, computing device(s) 132 is shown in communication with AMS 100, and its various components (e.g., build platform 102, build plate 112, recoater device 120 including blade 124, energy emitting device(s) 128, and so on). As is known, in general, processing component 160 executes computer program code, such as control system 134, that is stored in storage component 158 or an external storage component 166. While executing computer program code, processing component 160 can read and/or write data, such as control system 134, to/from storage component 158 and/or I/O component 162. Bus 164 provides a communications link between each of the components in computing device(s) 132. I/O component 162 can comprise any device that enables a user 168 to interact with computing device(s) 132 or any device that enables computing device(s) 132 to communicate with one or more other computing devices. Input/output components 162 (including but not limited to keyboards, displays, pointing devices, etc.) can be coupled to the system either directly or through intervening I/O controllers.

In any event, computing device(s) 132 can comprise any general purpose computing article of manufacture capable of executing computer program code installed by a user 168 (e.g., a personal computer, server, handheld device, etc.). However, it is understood that computing device(s) 132 and control system 134 are only representative of various possible equivalent computing devices that may perform the various process steps of the disclosure. To this extent, in other embodiments, computing device(s) 132 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 156 is only illustrative of various types of computer infrastructures for implementing the disclosure. For example, in one embodiment, computer infrastructure 156 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may use any combination of various types of transmission techniques.

As previously mentioned and discussed herein, control system 134 enables computing infrastructure 156 to control operation of AMS 100. To this extent, control system 134 is shown including measurement device(s) data 170, predetermined measurement data 172, operational characteristics data 174, and build characteristics data 176. Measurement device(s) data 170 may include program code related to determining, measuring, and/or detecting test marks 140 formed on build plate 112 or calibration plate 146 by energy emitting device(s) 128 and detected by measurement device(s) 136 (see, FIGS. 1 and 2). Predetermined measurement data 172 may include program code related to reference marks 138 and predetermined, desired locations for reference marks 138 formed on build plate 112 or calibration plate 146, as discussed herein. Operational characteristics data 174 may include program code related to the operation and/or control of AMS 100, and specifically components of AMS 100 including build platform 102, recoater device 120, energy emitting device(s) 128, and the like.

Build characteristics data 176 may include program code related to the component intended to be built by AMS 100, which may include information and/or data specific to the features, geometry and/or layers of the component, as discussed herein. Additionally operation of each of these data 170-176 is discussed further herein. However, it is understood that some of the various data shown in FIG. 9 can be implemented independently, combined, and/or stored in memory for one or more separate computing devices that are included in computer infrastructure 156. Further, it is understood that some of the data and/or functionality may not be implemented, or additional data and/or functionality may be included as part of environment 154. In a non-limiting example, various data 170-176 may be stored on external storage device 166.

As discussed herein, build characteristics data 176 may include program code related to the component intended to be built by AMS 100, which may include information and/or data specific to the features, geometry and/or layers of the component. The program code of build characteristics data 176 may include a precisely defined 3D model of the component and can be generated from any of a large variety of well-known computer aided design (CAD) software systems such as AutoCAD®, TurboCAD®, DesignCAD 3D Max, etc. In this regard, the program code of build characteristics data 176 can take any now known or later developed file format. For example, the program code of build characteristics data 176 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. The program code of build characteristics data 176 may be translated between different formats, converted into a set of data signals and transmitted, received as a set of data signals and converted to code, stored, etc., as necessary. The program code of build characteristics data 176 may be an input to computing device(s) 132 and/or storage component 158, and may come from a part designer, an intellectual property (IP) provider, a design company, user(s) 168 of computing device(s) 132, external storage device 166, or from other sources. As discussed herein, computing device(s) 132 and/or control system 134 executes the program code of build characteristics data 176, and divides the component into a series of defined layers, which may be individually transformed after formation by energy emitting device(s) 128 to form the component.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data (e.g., obtaining measurement device(s) data 170, obtaining build characteristics data 176 for component, etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system comprising:
a movable build platform;
at least one energy emitting device positioned above the movable build platform, the at least one energy emitting device configured to form a test mark directly on a reference surface; and
a calibration system operably connected to the at least one energy emitting device, the calibration system including:
at least one measurement device positioned above the movable build platform, the at least one measurement device configured to determine an actual location of the test mark on the reference surface; and
at least one computing device operably connected to the at least one energy emitting device and the at least one measurement device, the at least one computing device configured to calibrate the at least one energy emitting device by:
adjusting the at least one energy emitting device in response to determining the actual location of the test mark on the reference surface differs from a predetermined, desired location on the reference surface.

2. The additive manufacturing system of claim 1, wherein the at least one computing device of the calibration system is configured to adjust the at least one energy emitting device by:
altering a position of at least one mirror of the at least one energy emitting device until the actual location of the test mark on the reference surface is identical to the predetermined, desired location on the reference surface.

3. The additive manufacturing system of claim 2, wherein the at least one computing device of the calibration system is configured to alter the position of the at least one mirror of the at least one energy emitting device by at least one of:
displacing the at least one mirror of the at least one energy emitting device, or
adjusting an inclination of the at least one mirror of the at least one energy emitting device.

4. The additive manufacturing system of claim 1, wherein the reference surface includes at least one of:
a build surface of a build plate positioned on the movable build platform,
a surface of the movable build platform,
a calibration surface of a calibration plate positioned on the movable build platform, or
an exposed surface of a support table substantially surrounding the movable build platform.

5. The additive manufacturing system of claim 1, wherein the at least one computing device of the calibration system is configured to adjust the at least one energy emitting device by:
altering the position of the at least one energy emitting device until the test mark is formed substantially over a reference mark formed on the reference surface in the predetermined, desired location.

6. The additive manufacturing system of claim 5, wherein the at least one computing device of the calibration system is configured to alter the position of the at least one energy emitting device by at least one of:
displacing the at least one energy emitting device, or
rotating the at least one energy emitting device.

7. The additive manufacturing system of claim 1, wherein the at least one measurement device is one of:
coupled to a recoater device positioned directly above the reference surface,
positioned within a build chamber, and above the reference surface, or
positioned above the build chamber, and above the reference surface.

8. A calibration system operably connected to at least one energy emitting device of an additive manufacturing system, the calibration system comprising:
a reference mark formed on a reference surface in a predetermined, desired location;
at least one measurement device positioned above the reference surface, the at least one measurement device configured to determine an actual location of a test mark made by the at least one energy emitting device on the reference surface; and
at least one computing device operably connected to the at least one energy emitting device and the at least one measurement device, the at least one computing device configured to calibrate the at least one energy emitting device by:
adjusting the at least one energy emitting device in response to determining the actual location of the test mark on the reference surface differs from the reference mark formed in the predetermined, desired location on the reference surface.

9. The calibration system of claim 8, wherein the at least one computing device is configured to adjust the at least one energy emitting device by:
altering a position of at least one mirror of the at least one energy emitting device until the actual location of the test mark on the reference surface is substantially identical to the predetermined, desired location on the reference surface.

10. The calibration system of claim 9, wherein the at least one computing device is configured to alter the position of the at least one mirror of the at least one energy emitting device by at least one of:
displacing the at least one mirror of the at least one energy emitting device, or
adjusting an inclination of the at least one mirror of the at least one energy emitting device.

11. The calibration system of claim 8, wherein the reference surface includes at least one of:
a build surface of a build plate positioned on a movable build platform of the additive manufacturing system,
a surface of the movable build platform of the additive manufacturing system,
a calibration surface of a calibration plate positioned on the movable build platform of the additive manufacturing system, or
an exposed surface of a support table substantially surrounding the movable build platform of the additive manufacturing system.

12. The calibration system of claim 8, wherein the at least one computing device is configured to adjust the at least one energy emitting device by:
altering the position of the at least one energy emitting device until the test mark is formed substantially over the reference mark formed on the reference surface in the predetermined, desired location.

13. The calibration system of claim 8, wherein the at least one computing device is configured to alter the position of the at least one energy emitting device by:
displacing the at least one energy emitting device, or
rotating the at least one energy emitting device.

14. The calibration system of claim 8, wherein the at least one measurement device is one of:
coupled to a recoater device of the additive manufacturing system positioned above the reference surface,
positioned within a build chamber of the additive manufacturing system, and above the reference surface, or
positioned above the build chamber of the additive manufacturing system, and above the reference surface.

15. A computer program product comprising program code stored on a non-transitory computer readable storage medium, which when executed by at least one computing device, causes the at least one computing device to calibrate at least one energy emitting device of an additive manufacturing system by performing processes including:
adjusting the at least one energy emitting device in response to determining an actual location of a test mark formed on a reference surface of the additive manufacturing system differs from a predetermined, desired location on the reference surface,
wherein the at least one energy emitting device is configured to form the test mark directly on the reference surface.

16. The computer program product of claim 15, wherein adjusting the at least one energy emitting device includes:
altering a position of at least one mirror of the at least one energy emitting device until the actual location of the test mark on the reference surface is substantially identical to the predetermined, desired location on the reference surface.

17. The computer program product of claim 16, wherein altering the position of the at least one mirror of the at least one energy emitting device includes at least one of:
displacing the at least one mirror of the at least one energy emitting device, or
adjusting an inclination of the at least one mirror of the at least one energy emitting device.

18. The computer program product of claim 15, wherein adjusting the at least one energy emitting device includes:
altering the position of the at least one energy emitting device until the test mark is formed substantially over a reference mark formed on the reference surface in the predetermined, desired location.

19. The computer program product of claim 18, wherein altering the position of the at least one energy emitting device includes at least one of:
displacing the at least one energy emitting device, or
rotating the at least one energy emitting device.
